(19) United States
(12) Patent Application Publication
(10) Pub. No.: US 2009/0089349 A1
(43) Pub. Date: Apr. 2, 2009

(54) Angle Computation Method and Related Circuit

(76) Inventors: Chi-Tung Chang, Taipei City (TW); Hua-Han Lee, Taoyuan County (TW); Yu-Ling Chen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/941,072

(22) Filed: Nov. 15, 2007

(30) Foreign Application Priority Data
Sep. 27, 2007 (TW) 096136003

(51) Int. Cl. G06F 7/548

(52) U.S. Cl. 708/440

(57) ABSTRACT

Computing an angle between a real part and an imaginary part of a complex number includes receiving complex number data; generating a first value, a second value and a determination result according to the complex number data; choosing a dividend and a divisor of a division operation from the first value and the second value for generating a division result according to magnitudes of the first value and the second value; performing table look-up for the division result to generate a table look-up result according to a preserved table; and adjusting the table look-up result for generating an angle corresponding to the complex number data according to the determination result.

### BACKGROUND OF THE INVENTION

1. Field of the Invention

The present invention relates to an angle computation method and related circuit, and more particularly, to an angle computation method and related circuit for obtaining angles of complex numbers by utilizing a small range arctangent table and simple shifter and subtractor circuits.

2. Description of the Prior Art

In the field of circuit design, a coordinate rotation digital computer (CORDIC) is a well-known circuit unit for computing a rotation angle of a vector or an angle between a real part and an imaginary part of a complex number, and moreover, it can be realized by simple circuit elements, like multipliers and adders, so that it has benefits of low power consumption and low circuit cost. However, due to the use of recursive computation approximation methods, the CORDIC generally has a shortcoming of slow computing speed, and thus it can hardly be applied in high-speed circuit design, such as ultra-wideband (UWB) technology.

Table look-up is also a common way to obtain the angle between the real part and the imaginary part of the complex number, which is carried out by performing table look-up for a quotient obtained from dividing the imaginary part by the real part to find the angle of the complex number according to an arctangent table. For example, if the real part and the imaginary part of an input complex number data IN_COM are respectively represented by X and Y, i.e. IN_COM=X+jY, the angle ANG of the input complex number data IN_COM is an arctangent value of a quotient Y/X, which is obtained from dividing the imaginary part Y by the real part X, i.e. ANG=arctan(Y/X). Furthermore, since the quadrant in which the angle ANG is located can be determined by signs of the real part X and the imaginary part Y, circuit designers only need to find the angle of the first quadrant corresponding to the quotient Y/X, (i.e. the angle corresponding to the absolute value of the quotient |Y/X|) when designing circuits. Then, the actual angle between the real part X and the imaginary part Y of the complex number data IN_COM can be obtained according to the signs of the real part X and the imaginary part Y. In this case, the range of the arctangent table that needs to be stored in the circuit can be 0-∞. In addition, since arctan(∞) equals π/2, and there is only a 2% error between arctan(32) and π/2, and a 1% error between arctan(64) and π/2, in general, the circuit designer may approximate the upper limit of the pre-stored arctangent table from ∞ to 64 or 32, which can also be represented by 2̂5 or 2̂6. On the other hand, when the quotient Y/X is very small, such as Y/X<2̂−2 or Y/X<2̂−3, the arctangent value of the quotient Y/X approximately equals the value of the quotient Y/X, i.e. arctan(Y/X)≅Y/X. Thus, when utilizing the two approximation methods described above, the range of the arctangent table that needs to be stored in the circuit can be significantly scaled down from 0-∞ to 0.25-32.

However, the arctangent table with the range between 0.25 and 32 still needs to be stored in the conventional circuits, and thus enormous circuit area is consumed. Further, although the table look-up approach can improve computing speed, this approach needs divider circuits or look-up tables of reciprocal values along with multiplier circuits, resulting in higher power consumption.

### SUMMARY OF THE INVENTION

It is therefore a primary objective of the present invention to provide an angle computation method and related circuit.

The present invention discloses a method for computing angles between real parts and imaginary parts of complex numbers. The method comprises receiving complex number data; generating a first value, a second value and a determination result according to the complex number data, among which the first value and the second value correspond to absolute values of a real part and an imaginary part of the complex number data, respectively, and the determination result comprises sign information and absolute value information of the real part and the imaginary part of the complex number data; choosing a dividend and a divisor of a division operation from the first value and the second value for generating a division result according to magnitudes of the first value and the second value; performing table look-up for the division result to generate a table look-up result according to a preserved angle table; and adjusting the table look-up result for generating an angle corresponding to the complex number data according to the determination result.

The present invention further discloses a circuit for computing angles between real parts and imaginary parts of complex numbers. The circuit comprises a determination unit for generating a first value, a second value and a determination result according to a complex number data, among which the first value and the second value are corresponding to absolute values of a real part and an imaginary part of the complex number data, respectively, and the determination result comprises sign information and absolute value information of the real part and the imaginary part of the complex number data; a division unit, coupled to the determination unit, for choosing a dividend and a divisor of a division operation from the first value and the second value to generate a division result according to magnitudes of the first value and the second value; a table look-up unit, coupled to the division unit, for performing table look-up for the division result to generate a table look-up result according to a preserved angle table; and an angle adjustment unit, coupled to the table look-up unit and the determination unit, for adjusting the table look-up result for generating an angle corresponding to the complex number data according to the determination result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an angle computation process according to an embodiment of the present invention.

FIG. 2 is a schematic diagram of a division operation process in the embodiment of FIG. 1.

FIG. 3 is a schematic diagram of an angle computation circuit according to an embodiment of the present invention.

### DETAILED DESCRIPTION

In order to clarify the present invention, please refer to the following Euler equation in advance: Arctan(a)+Arctan(b)=Arctan((a+b)/(1−a*b)), among which a*b<1. By observing the above equation carefully, when b approaches 1/a, the above equation can be rewritten as: Arctan(a)+Arctan(1/a)=π/2. That means, the sum of arctangent values of an arbitrary value and its reciprocal value is equal to π/2, or 90 degrees. Therefore, based on such a relationship, the present invention can significantly scale down the range of the arctangent table needed to be stored in the circuit.

For example, if the real part and the imaginary part of input complex number data IN_COM are respectively represented by X and Y, i.e. IN_COM=X+jY, an angle ANG between the real part X and the imaginary part Y of the complex number data IN_COM is the arctangent value of a quotient Y/X obtained from dividing the imaginary part Y by the real part X, i.e. ANG=arctan(Y/X). Furthermore, since the quadrant in which the angle ANG is located can be determined by signs of the real part X and the imaginary part Y, circuit designers only need to find the angle of the first quadrant corresponding to the quotient Y/X, i.e. the angle corresponding to the absolute value of the quotient |Y/X|, when designing circuits. Then, the actual angle between the real part X and the imaginary part Y of the complex number data IN_COM can be obtained according to the signs of the real part X and the imaginary part Y. In this case, the range of the arctangent table that needs to be stored in circuits can be from 0.25 to 32. Thus, if the magnitude of the real part X is greater than or equal to that of the imaginary part Y, i.e. |X|≧|Y| or |Y/X|≦1, the present invention only needs an arctangent table having range from 0.25 to 1 to perform table look-up to find an angle in the first quadrant corresponding to the quotient Y/X, i.e. the angle corresponding to the quotient |Y/X|, so that the angle ANG of the input complex number data IN_COM can be further obtained according to the signs of the real part X and the imaginary part Y.

On the contrary, if the magnitude of the real part X is less than that of the imaginary part Y, i.e. |X|<|Y| or |X/Y|<1, since the sum of arctangent values of the quotient |Y/X| and the quotient |X/Y| is equal to π/2 as mentioned above, the present invention can first perform table look-up by utilizing the arctangent table ranging between 0.25 and 1 to find the arctangent value of the quotient |X/Y|, and can further obtain the arctangent value of the quotient |Y/X|. Thus, utilizing the arctangent table ranging only from 0.25 to 1, the present invention can obtain the angle in the first quadrant corresponding to the quotient Y/X, i.e. the angle corresponding to the quotient |Y/X|, so as to obtain further the angle ANG between the real part X and the imaginary part Y of the input complex number data IN_COM.

Therefore, the present invention need only store the arctangent table with the range from 0.25-1 in circuits, and can thus obtain the angle between the real part X and the imaginary part Y, so as to reduce the circuit area significantly. Further, when finding the quotient |Y/X| or |X/Y|, the magnitudes of the absolute values of the real part X and the imaginary part Y are determined in advance, and thus the division operation in the present invention can be realized by simple shifter and subtractor circuits.

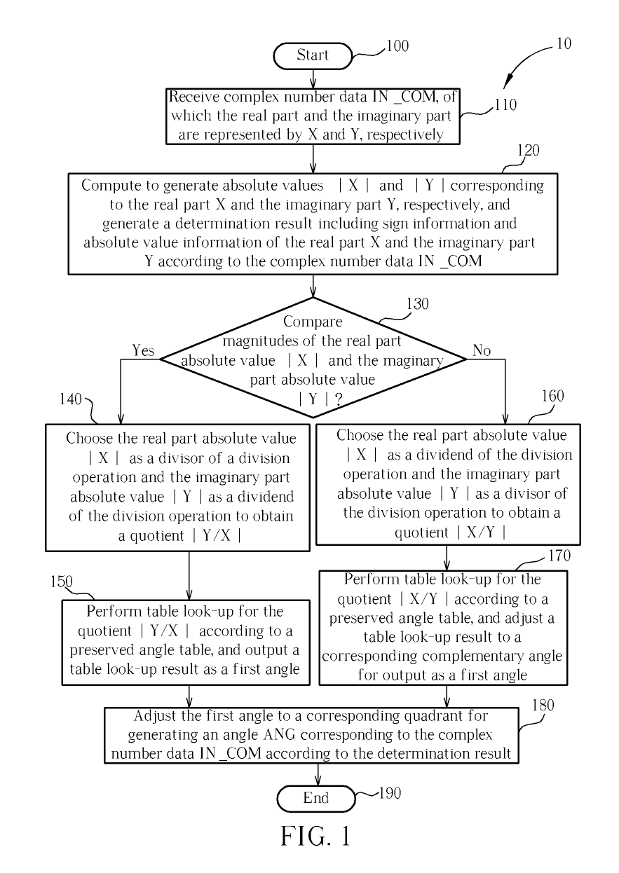

Please refer to FIG. 1. FIG. 1 is a schematic diagram of an angle computation process 10 according to an embodiment of the present invention. The angle computation process 10 includes the following steps:

Step 100: Start.

Step 110: Receive complex number data IN_COM, of which the real part and the imaginary part are represented by X and Y, respectively.

Step 120: Compute to generate absolute values |X| and |Y| corresponding to the real part X and the imaginary part Y, respectively, and generate a determination result including sign information and absolute value information of the real part X and the imaginary part Y according to the complex number data IN_COM.

Step 130: Compare magnitudes of the real part absolute value |X| and the imaginary part absolute value |Y|. If the real part absolute value |X| is greater than the imaginary part absolute value |Y|, proceed to Step 140; if the real part absolute value |X| is less than the imaginary part absolute value |Y|, proceed to Step 160.

Step 140: Choose the real part absolute value |X| as a divisor of a division operation and the imaginary part absolute value |Y| as a dividend of the division operation to obtain a quotient |Y/X|.

Step 150: Perform table look-up for the quotient |Y/X| according to a preserved angle table, and output a table look-up result as a first angle. Proceed to Step 180.

Step 160: Choose the real part absolute value |X| as a dividend of the division operation and the imaginary part absolute value |Y| as a divisor of the division operation to obtain a quotient |X/Y|.

Step 170: Perform table look-up for the quotient |X/Y| according to a preserved angle table, and adjust a table look-up result to a corresponding complementary angle for output as a first angle. Proceed to Step 180.

Step 180: Adjust the first angle to a corresponding quadrant for generating an angle ANG corresponding to the complex number data IN_COM according to the determination result.

Step 190: End.

According to the angle computation process 10, the present invention first computes to generate the real part absolute value |X| and the imaginary part absolute value |Y| according to the complex number data IN_COM and generate the determination result including the sign information and the absolute value information of the real part X and the imaginary part Y (Step 120). Then, the present invention chooses the dividend and the divisor of the division operation to generate a division result according to the magnitudes of the real part absolute value |X| and the imaginary part absolute value |Y|. Preferably, when the real part absolute value |X| is greater than the imaginary part absolute value |Y|, the present invention chooses the real part absolute value |X| as the divisor of the division operation and the imaginary part absolute value |Y| as the dividend of the division operation to obtain the quotient |Y/X| (Step 140); and conversely, when the real part absolute value |X| is less than the imaginary part absolute value |Y|, the present invention chooses the real part absolute value |X| as the dividend of the division operation and the imaginary part absolute value |Y| as the divisor of the division operation to generate the quotient |X/Y| (Step 160). In this case, since the dividend is less than the divisor in the division operation of the present invention, the present invention can thus realize the division operation by simple shifter and subtractor circuits. Additionally, since the division result, i.e. the quotient |Y/X| or |X/Y|, is a value less than 1, the present invention can perform table look-up for the quotient |Y/X| or |X/Y| to generate the table look-up result, i.e. the angle corresponding to the quotient |Y/X| or |X/Y|) according to a pre-stored arctangent table with range of 0.25-1.

Then, by the relation derived from the above Euler equation, the present invention can process the table look-up result to generate the first angle, i.e. an angle corresponding to the quotient |Y/X| or |X/Y|. That means, when the table look-up result is the angle corresponding to the quotient |Y/X| (Step 150), the present invention directly outputs the table look-up result as the first angle and proceeds to Step 180; and when the table look-up result represents the angle corresponding to the quotient |X/Y| (Step 170), the present invention then generates a complementary angle corresponding to the table look-up result for output as the first angle by utilizing the relationship derived from the above Euler equation.

Finally, according to the sign information of the real part X and the imaginary part Y, the present invention can adjust the first angle, i.e. the angle corresponding to the quotient |Y/X|, to a corresponding quadrant for generating the angle ANG between the real part X and the imaginary part Y of the complex number data IN_COM (Step 180). For example, when the real part X and the imaginary part Y of the complex number data IN_COM are both positive numbers, since the angle corresponding to the quotient Y/X is located in the first quadrant, the present invention can directly output the first angle to be the angle ANG of the complex number data IN_COM. When the real part X and the imaginary part Y are a negative number and a positive number, respectively, since the arctangent value, i.e. an angle, corresponding to the quotient Y/X is located in the second quadrant, the present invention then adjusts the first angle to be a corresponding supplementary angle for output as the angle ANG of the complex number data IN_COM. When the real part X and the imaginary part Y are both negative numbers, since the angle corresponding to the quotient Y/X is located in the third quadrant, the first angle is adjusted to be a negative of the first angle and then outputted as the angle ANG of the complex number data IN_COM. And, likewise, when the real part X and the imaginary part Y are a positive number and a negative number, respectively, since the angle corresponding to the quotient Y/X is located in the fourth quadrant, the first angle has to be adjusted to be a negative of a corresponding supplementary angle and then outputted as the angle ANG of the complex number data IN_COM.

Therefore, with the angle computation process 10, the present invention only needs to store the arctangent table with the range of 0.25-1 in circuits, and can thus obtain the angle between the real part X and the imaginary part Y, so as to reduce the circuit area significantly. Additionally, by determining the magnitudes of the absolute values of the real part X and the imaginary part Y in advance, the dividend is less than the divisor in the division operation of the present invention, so that the present invention can easily realize the division operation by simple shifter and subtractor circuits.

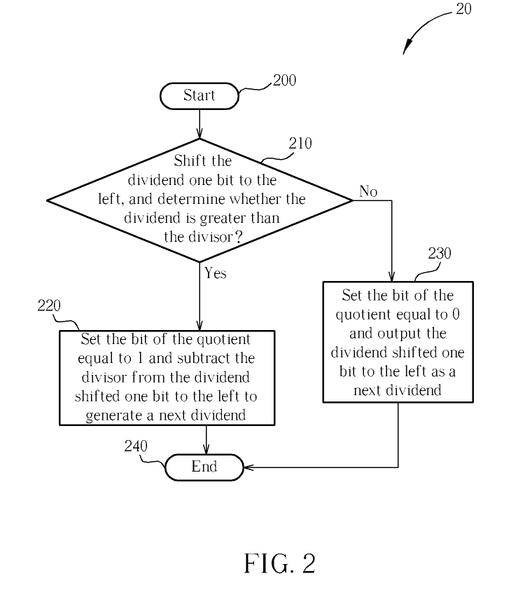

For example, please refer to FIG. 2. FIG. 2 is a schematic diagram of a division operation process 20 in the embodiment of FIG. 1. The division operation process 20 includes the following steps:

Step 200: Start.

Step 210: Shift the dividend one bit to the left, and determine whether the dividend is greater than the divisor. If so, proceed to Step 220; if not, proceed to Step 230.

Step 220: Set the bit of the quotient equal to 1 and subtract the divisor from the dividend shifted one bit to the left to generate a next dividend. Proceed to Step 240.

Step 230: Set the bit of the quotient equal to 0 and output the dividend shifted one bit to the left as a next dividend. Proceed to Step 240.

Step 240: End.

Therefore, according to the division operation process 20, since the dividend is less than the divisor in the division operation of the present invention, the present invention can thus first shift the dividend one bit to the left and check whether the shifted result is greater than the divisor. If the dividend shifted one bit to the left is greater than the divisor, the present invention outputs the bit of the quotient to be 1, and subtracts the divisor from the dividend shifted one bit to the left to generate a next dividend. On the contrary, if the dividend shifted one bit to the left is less than the divisor, the present invention outputs the bit of the quotient to be 0, and outputs the dividend shifted one bit to the left to be a next dividend. Such steps have to be repeated until the number of the bits of the outputted quotient meets required accuracy. Thus, without utilizing divider circuits, the present invention can easily realize the division operation by simple shifter and subtractor circuits, so that power consumption can be saved.

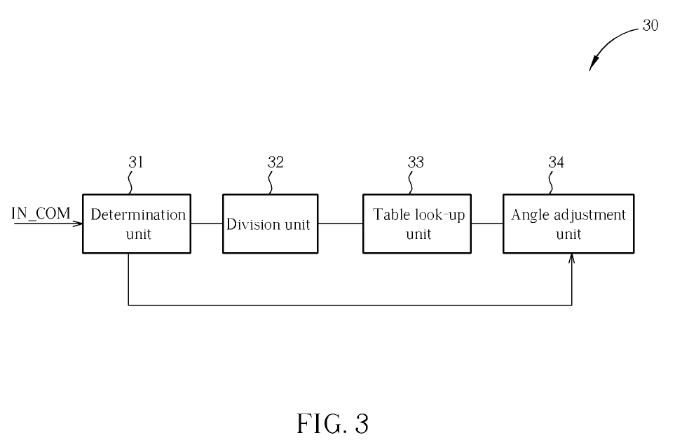

Please refer to FIG. 3. FIG. 3 is a schematic diagram of an angle computation circuit 30 according to an embodiment of the present invention. The angle computation circuit 30 is utilized for realizing the angle computation process 10 of the present invention, and comprises a determination unit 31, a division unit 32, a table look-up unit 33 and an angle adjustment unit 34. The determination unit 31 is utilized for computing the real part absolute value |X| and the imaginary part absolute value |Y| according to the received complex number data IN_COM, and for generating the determination result including the sign information and the absolute value information of the real part X and the imaginary part Y. The division unit 32 is coupled to the determination unit 31, and is utilized for choosing the dividend and the divisor of the division operation according to the magnitudes of the real part absolute value |X| and the imaginary part absolute value |Y| and for performing the division operation process 20. Preferably, the division unit 32 can be implemented by simple shifter and subtractor circuits. The table look-up unit 33 is coupled to the division unit 32, and is utilized for performing table look-up for the division result outputted by the division unit 32 to generate the table look-up result according to a pre-stored arctangent table, among which the range of the arctangent table is preferably 0.25-1. The angle adjustment unit 34 is coupled to the table look-up unit 33 and the determination unit 31, and is utilized for adjusting the table look-up result to generate the angle ANG of the complex number data IN_COM according to results outputted by the determination unit 31. The detailed operations of the angle computation circuit 30 are illustrated in the above, and thus are not described again.

As mentioned above, by the relationship derived from the Euler equation, the present invention can perform table look-up to obtain the angle between the real part and the imaginary part of the complex number data according to the small range arctangent table. Thus, the present invention can significantly reduce the angles stored in the circuits, while maintaining the same accuracy, so that the circuit area can be significantly reduced. Additionally, the division operation of the present invention can be realized by simple shifter and subtractor circuits, so that the present invention can save power consumption, and meanwhile, can be applied in various high-speed circuits, such as ultra wide band (UWB) circuits.

Those skilled in the art will readily observe that numerous modifications and alterations of the device and method may be made while retaining the teachings of the invention.

What is claimed is:

1. A method for computing an angle between a real part and an imaginary part of a complex number comprising:
receiving complex number data;
generating a first value, a second value and a determination result according to the complex number data, wherein the first value and the second value correspond to absolute values of a real part and an imaginary part of the complex number data, respectively, and the determination result comprises sign information and absolute value information of the real part and the imaginary part of the complex number data;
choosing a dividend and the divisor of the division operation from the first value and the second value for generating a division result according to magnitudes of the first value and the second value;
performing table look-up for the division result to generate a table look-up result according to a preserved angle table; and
adjusting the table look-up result for generating an angle corresponding to the complex number data according to the determination result.

2. The method of claim 1, wherein choosing the dividend and the divisor of the division operation from the first value and the second value for generating the division result according to the magnitudes of the first value and the second value comprises choosing the first value as the divisor of the division operation and the second value as the dividend of the division operation for generating the division result when the first value is greater than the second value.

3. The method of claim 1, wherein choosing the dividend and the divisor of the division operation from the first value and the second value for generating the division result according to the magnitudes of the first value and the second value comprises choosing the first value as the dividend of the division operation and the second value as the divisor of the division operation for generating the division result when the first value is less than the second value.

4. The method of claim 1, wherein the division operation is implemented by shift and subtraction.

5. The method of claim 1, wherein the preserved angle table is an arctangent table having range less than 1.

6. The method of claim 5, wherein the preserved angle table ranges between 0.25 and 1.

7. The method of claim 1, wherein adjusting the table look-up result for generating the angle corresponding to the complex number data according to the determination result comprises:
processing the table look-up result for generating a first angle according to the magnitudes of the first value and the second value; and
adjusting the first angle to a corresponding quadrant for generating the angle corresponding to the complex number data according to the sign information of the real part and the imaginary part of the complex number data.

8. The method of claim 7, wherein processing the table look-up result for generating the first angle according to the magnitudes of the first value and the second value comprises outputting the table look-up result as the first angle when the first value is greater than the second value.

9. The method of claim 7, wherein processing the table look-up result for generating the first angle according to the magnitudes of the first value and the second value comprises adjusting the table look-up result to be a corresponding complementary angle and outputting the corresponding complementary angle as the first angle when the first value is less than the second value.

10. The method of claim 7, wherein adjusting the first angle to the corresponding quadrant for generating the angle corresponding to the complex number data according to the sign information of the real part and the imaginary part of the complex number data comprises outputting the first angle as the angle corresponding to the complex number data when the real part and the imaginary part of the complex number data are both positive numbers.

11. The method of claim 7, wherein adjusting the first angle to the corresponding quadrant for generating the angle corresponding to the complex number data according to the sign information of the real part and the imaginary part of the complex number data comprises adjusting the first angle to be a corresponding supplementary angle and outputting the corresponding supplementary angle as the angle corresponding to the complex number data when the real part and the imaginary part of the complex number data are a negative number and a positive number, respectively.

12. The method of claim 7, wherein adjusting the first angle to the corresponding quadrant for generating the angle corresponding to the complex number data according to the sign information of the real part and the imaginary part of the complex number data comprises adjusting the first angle to be a negative of a corresponding supplementary angle and outputting the negative of the corresponding supplementary angle as the angle corresponding to the complex number data when the real part and the imaginary part of the complex number data are a positive number and a negative number, respectively.

13. The method of claim 7, wherein adjusting the first angle to the corresponding quadrant for generating the angle corresponding to the complex number data according to the sign information of the real part and the imaginary part of the complex number data comprises adjusting the first angle to be a negative of the first angle and outputting the negative of the first angle as the angle corresponding to the complex number data when the real part and the imaginary part of the complex number data are both negative numbers.

14. A circuit for computing an angle between a real part and an imaginary part of a complex number comprising:
a determination unit for generating a first value, a second value and a determination result according to complex number data, wherein the first value and the second value correspond to absolute values of a real part and an imaginary part of the complex number data, respectively, and the determination result comprises sign information and absolute value information of the real part and the imaginary part of the complex number data;
a division unit, coupled to the determination unit, for choosing a dividend and a divisor of a division operation from the first value and the second value to generate a division result according to magnitudes of the first value and the second value;
a table look-up unit, coupled to the division unit, for performing table look-up for the division result to generate a table look-up result according to a preserved angle table; and
an angle adjustment unit, coupled to the table look-up unit and the determination unit, for adjusting the table look-up result for generating an angle corresponding to the complex number data according to the determination result.

15. The circuit of claim 14, wherein the division unit is utilized for choosing the first value as the divisor of the division operation and the second value as the dividend of the division operation for generating the division result when the first value is greater than the second value.

16. The circuit of claim 14, wherein the division unit is utilized for choosing the first value as the dividend of the division operation and the second value as the divisor of the division operation for generating the division result when the first value is less than the second value.

17. The circuit of claim 14, wherein the division unit comprises a shifter and a subtractor.

18. The circuit of claim 14, wherein the preserved angle table is an arctangent table ranging between 0.25 and 1.

19. The circuit of claim 14, wherein the adjustment unit is further utilized for processing the table look-up result for generating a first angle according to the magnitudes of the first value and the second value, and for adjusting the first angle to a corresponding quadrant for generating the angle corresponding to the complex number data according to the sign information of the real part and the imaginary part of the complex number data.

20. The circuit of claim 19, wherein the adjustment unit is utilized for outputting the table look-up result as the first angle when the first value is greater than the second value.

21. The circuit of claim 19, wherein the adjustment unit is utilized for adjusting the table look-up result to a corresponding complementary angle and outputting the corresponding complementary angle as the first angle when the first value is less than the second value.

22. The circuit of claim 19, wherein the adjustment unit is utilized for outputting the first angle as the angle corresponding to the complex number data when the real part and the imaginary part of the complex number data are both positive numbers.

23. The circuit of claim 19, wherein the adjustment unit is utilized for adjusting the first angle to be a corresponding supplementary angle and outputting the corresponding supplementary angle as the angle corresponding to the complex number data when the real part and the imaginary part of the complex number data are a negative number and a positive number, respectively.

24. The circuit of claim 19, wherein the adjustment unit is utilized for adjusting the first angle to be a negative of a corresponding supplementary angle and outputting the negative of the corresponding supplementary angle as the angle corresponding to the complex number data when the real part and the imaginary part of the complex number data are a positive number and a negative number, respectively.

25. The circuit of claim 19, wherein the adjustment unit is utilized for adjusting the first angle to be a negative of the first angle and outputting the negative of the first angle as the angle corresponding to the complex number data when the real part and the imaginary part of the complex number data are both negative numbers.
